(19) United States
(12) Patent Application Publication
(10) Pub. No.: US 2014/0204210 A1
(43) Pub. Date: Jul. 24, 2014

(54) Retrofitting Kit For Parking Guidance

(71) Applicants: Marcus Schneider, Ludwigsburg (DE); Thomas Scheuerle, Murr (DE)

(72) Inventors: Marcus Schneider, Ludwigsburg (DE); Thomas Scheuerle, Murr (DE)

(21) Appl. No.: 14/125,761

(22) PCT Filed: May 15, 2012
(86) PCT No.: PCT/EP2012/059037

§ 371 Date: Mar. 27, 2014

(30) Foreign Application Priority Data
Jun. 15, 2011 (DE) 102011077555.2

(51) Int. Cl. G06K 9/00

(52) U.S. Cl. CPC G06K 9/00805
USPC 348/148

(57) ABSTRACT

A method for ascertaining a relative position between a vehicle and an object located laterally to the vehicle, and a retrofitting kit having components to carry out this method. The object is initially detected in that the vehicle passes the object at least once. Subsequently, the vehicle movement is detected by a camera system which is situated in the vehicle and which generates video images at different recording points in time. Then, the detected vehicle movement is linked to the installation position of the camera system in the vehicle, the position of the at least one object detection sensor and a reference point. Next, the relative position change of the vehicle relative to the previously detected object is determined.

### FIELD OF THE INVENTION

The present invention relates to a method for ascertaining a relative position between a vehicle and an object as well as a device for carrying out the method.

### BACKGROUND INFORMATION

German patent document DE 10 2006/010295 A1 relates to a stereo camera system for object detection in traffic. A camera system is used for speed detection. This camera system includes at least two different image recorders. The recording ranges of the individual image recorders overlap at least partially and the data of the image recorders are combined into a 3-D image. In one particular embodiment, image recorders are provided which are sensitive in different spectral ranges.

German patent document DE 10 2005/003 354 A1 is directed to a camera for detecting a speed, in particular a relative speed between a collision object and a vehicle. A relative speed and a distance between the one collision object and the vehicle are detected at different measurement times while the collision object is approaching the vehicle. Possible collision points in time are computed in advance based on measured values of the relative speed and the distance. The measured values of the relative speed and the distance and/or actual collision points in time computed in advance are stored together with the measurement times, and an actual collision point in time of the vehicle with the collision object is detected. The actual collision point in time is compared to the possible collision points in time computed in advance, and the measured value of the relative speed is selected in such a way that the associated possible collision point in time computed in advance has the smallest deviation from the actual collision point in time.

German patent document DE 10 221 513 A1 discusses an image analysis for ascertaining a speed. A method is disclosed for displaying an original image, detected electronically in an original format, in a display format, deviating from the original format with regard to the width/height ratio, on a display unit as a deformed display image. A deformation function having at least one translation portion is determined which converts the original coordinates into display coordinates, a main area of the image being displayed in an unreformed manner and an adjacent area of the image being displayed in a deformed manner.

Driver assistance systems may provide one or multiple additional devices in a vehicle to assist the driver in certain driving situations. Such additional devices or subsystems are, for example, is SDW (side distance warning systems), ABS (anti-lock system), ESP (electronic stability program), ACC (adaptive cruise control), or PDC (park distance control).

In particular, in tight maneuvering situations such as parking or in situations in which the driver has only limited maneuvering options, driver assistance systems may assist the driver. For this purpose, driver assistance systems typically include a passive steering guidance, i.e., a steering guidance without active steering intervention by the driver. In this way, the driver may be assisted during parallel parking or cross parking. At least some of the driver assistance systems of this type may be integrated as standard into the vehicle, parking assist systems based on ultrasound being available as retrofitting kits which may also be installed by a lay person.

There are also believed to be driver assistance systems which assist the driver during maneuvering in difficult situations, e.g., in the parking garage, with the aid of audiovisual warning and information. Parking assist systems which are based on a rear view camera may also be implemented as easily installable DIY retrofitting kits according to one possible specific embodiment. Retrofitting kits which are easily installable in vehicles are ultrasound-based parking assist systems.

Furthermore, side distance warning (SDW) systems are believed to be understood in which a distance warning takes place for objects next to the vehicle, these objects being detected by a distance sensor during a previous pass and being tracked with regard to their position relative to the passing vehicle. Thus, these objects no longer have to be detected by the distance sensor at the point in time of the warning, which results in saving lateral sensors. In this context, the term “virtual lateral sensors” is customary. These systems differ from a conventional parking pilot functionality in that it is also possible to be warned and informed about objects and obstacles even if these are instantaneously not in the detection range of the sensor system, the sensor system potentially being based on ultrasound or radar. This is made possible by these systems internally forming a map or a comparable information structure from their surroundings and using it via the instantaneous vehicle position as a basis for detecting hazardous situations. For this reason, such systems need an odometry, i.e., a subsystem which provides the instantaneous vehicle position.

One difficulty which has emerged during the use of side distance warning systems is the fact that for determining the object position for the time in which the objects are no longer detected the vehicle movement relative to this object is to be determined very precisely. The reason for this is that carried out estimations of deviations from the actual position, e.g., in the order of magnitude of approximately 10 cm, may in fact result in a collision of such an object, e.g., an exterior mirror of the vehicle.

For this reason, it is believed to be necessary according to the embodiment variants of side distance warning systems known thus far to utilize the route information of the ESP or the ABS system of the vehicle. This, however, requires access to the onboard CAN bus (controller area network bus) and an exact knowledge of the particular CAN message(s) to be evaluated.

In particular in retrofittable systems, the access to an on board CAN bus is very difficult or not possible at all. In this way, it is only possible with great effort to provide a side distance warning system (SDW) in the form of a retrofitting kit.

### SUMMARY OF THE INVENTION

It is proposed according to the present invention to determine the vehicle movement of the vehicle relative to an object detected previously, e.g., during passing, on the basis of video information. For this purpose, a video camera is situated in the vehicle interior in the rear area of the vehicle in a predefined installation position with regard to a center of rotation of the vehicle, e.g., the center of the rear axle. Its image may be evaluated with regard to the movement of the camera relative to the surroundings. The detected movement is set in relation to the installation position of the camera and the object detection sensors using a computer. The object sensors may, for example, represent SDW sensors which may be attached laterally in the front of the vehicle as ultrasonic sensors.

Based on the relation, the relative position change of the vehicle with regard to the previously detected object is determined.

The approach proposed according to the present invention is to combine information which results from an object detection by ultrasonic distance sensors, i.e., by SDW sensors attached laterally on the vehicle, with a vehicle movement detected based on a shift of video images. In the approach proposed according to the present invention, a video camera fixedly installed in the rear area of the vehicle, for example, may be used which is installed in a vehicle similar to distance detection sensors which are retrofittable and which work according to the ultrasonic principle, for example. A retrofitting kit includes exactly this type of video camera attached on the rear side, a control unit having a signal output, acoustic or visual, and a connection to two distance detection sensors which are attached laterally on the vehicle and which may work according to the principle of ultrasonic distance measurement.

The detected movement of the vehicle may be set arithmetically in relation to the fixed installation position of the video camera and the object detection sensors, as well as the vehicle point of rotation. The detection of the movement of a vehicle proposed according to the present invention may also be utilized for passive parking guidance. This is to be understood as an assistance system for the driver of a vehicle which guides the driver with the aid of steering and driving instructions along a previously computed trajectory and assists with a parking maneuver which may take place in the reverse direction.

The approach proposed according to the present invention does not require access to an on board data bus, e.g., the on board CAN data bus. This provides the option of manufacturing a stand-alone system without linkage to other systems installed in the vehicle, such as the ABS system or the ESP system, so that the implementation of a retrofitting kit is possible while refraining from meeting the above-mentioned access requirements. The retrofitting kit according to the system proposed according to the present invention for determining the vehicle movement and ascertaining a collision may therefore be configured very cost-effectively, since it includes only a few components.

The components of the retrofitting kit proposed according to the present invention are the at least two sensors for side distance warning (SDW), a control unit, and a video camera to be mounted on the rear side, and corresponding data transmission lines between the above-mentioned components.

When using the approach proposed according to the present invention, a visual odometry is used due to the retrofitting kit in addition to the odometry which is typically installed in the vehicle and which works based on the wheel impulse sensor. Due to the visual geometry used in addition to the odometry typically installed in the vehicle, it is possible to increase the precision and availability of the typical odometry in particular in the area of low vehicle speeds. In this area, most on board wheel impulse sensors do not deliver reliable driving direction information which may be supported by the visual odometry of the device proposed according to the present invention by using the visual odometry.

The present invention is explained in greater detail below with reference to the drawings.

### BRIEF DESCRIPTION OF THE DRAWINGS

FIG. 1 shows a first driving situation of a vehicle which passes a laterally situated object.

FIG. 2 shows a second driving situation of the vehicle according to FIG. 1 after passing the object and while approaching it.

FIG. 3 shows in a schematic illustration the combination of information from the object detection and the tracking of the vehicle movement based on the video image evaluations recorded by a video camera in the interior of the vehicle.

### DETAILED DESCRIPTION

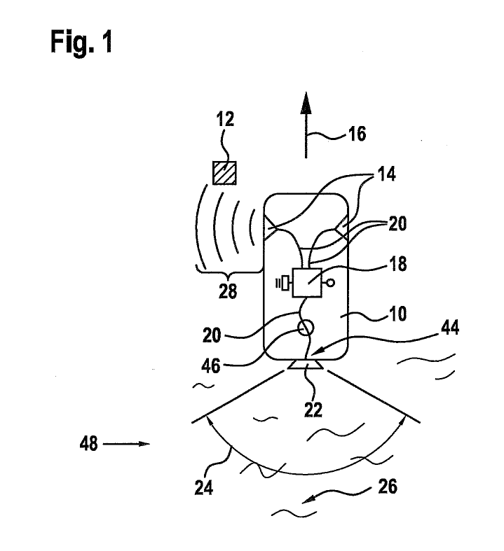

An approach proposed according to the present invention is described in the following with reference to one exemplary embodiment according to which a camera system, in particular a video camera, is situated in the rear area of a vehicle 10 and thus detects the area behind vehicle 10. There is also the option of installing camera system 22 in the area of the windshield or on one of the side windows of the vehicle. A fixed installation point of camera system 22 and its ability to continuously record images, in particular video images which are transmitted to a control unit 18, are crucial. The illustration according to FIG. 1 shows a vehicle 10 passing along an object 12 located on the left next to vehicle 10.

It is apparent from the illustration according to FIG. 1 that a vehicle 10 moves in driving direction 16. In the exemplary embodiment according to FIG. 1, laterally to vehicle 10, on the left side of vehicle 10, there is a stationary object 12, for example. This object 12 is detected during the movement of vehicle 10 in driving direction 16 by an object detection sensor 14 which is located in particular laterally on vehicle 10. Object detection sensors 14 may, for example, be ultrasonic sensors which are situated in the area of the fenders of vehicle 10 and transmit data to a control unit 18 via schematically situated connecting lines 20. Control unit 18 is connected to the power supply of vehicle 10 and represents, however, a retrofittable component of a retrofitting kit for ascertaining a relative position between a vehicle and an object 12 located laterally.

Furthermore, a camera system 22 is provided in vehicle 10, in particular in the rear area. Camera system 22 detects a detection area 24 which is located behind vehicle 10 and which includes a ground structure 26, for example, as indicated in FIG. 1. Camera system 22 is also connected for data exchange purposes via at least one connecting line 20 to control unit 18 also situated on the ceiling of vehicle 10, for example. Camera system 22 is in particular configured as a video camera which continuously records video images from which a vehicle movement may be ascertained, e.g., a trajectory 30 of vehicle 10 in driving direction 16. As already mentioned at the outset, camera system 22 may also be situated laterally within the passenger compartment or also in the area of the windshield of vehicle 10 instead of in the rear area of vehicle 10.

Reference numeral 46 refers to a reference point which may be illustrated by the center of the rear axle of vehicle 10, for example. Another fixed point of the chassis of vehicle 10 may also be selected as reference point 46, e.g., in vehicles having a rear drive, the transmission tunnel, or the like. Camera system 22 according to the present invention is mounted in a fixed to installation position 44 within vehicle 10, in this case in the rear area directly behind the rear window of vehicle 10, for example.

Object detection sensors 14 connected to control unit 18 via connecting lines 20 emit ultrasonic signals which run perpendicularly to the longitudinal side of vehicle 10, for example, and which are identified by a wave propagation 28.

The camera mounted in installation position 44—the camera is mounted in the rear area of vehicle 10 in the embodiment variant according to FIG. 1-continuously records video images at different recording points in time 48 and positions 50, which are also continuously transmitted to control unit 18.

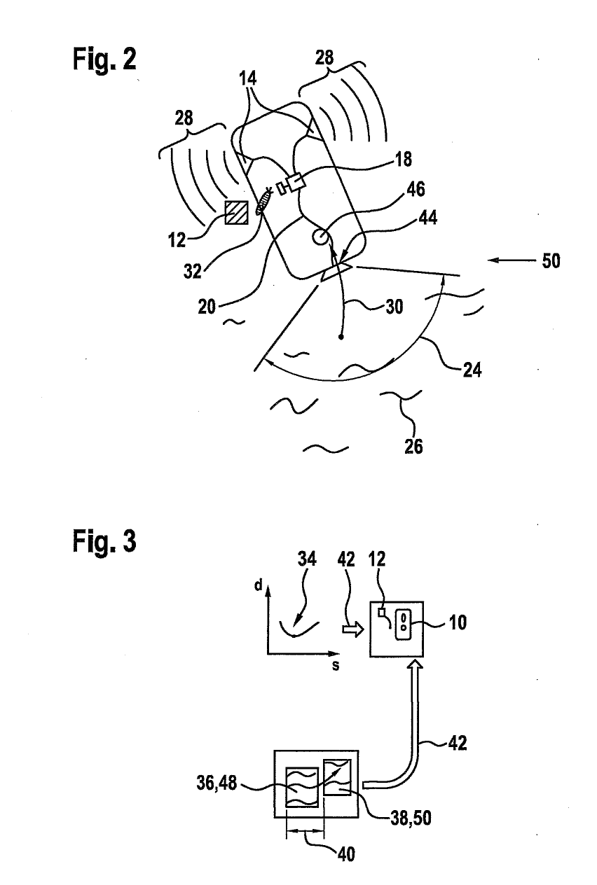

From the illustration according to FIG. 2, a driving situation of vehicle 10 is apparent in which, due to a corresponding steering angle, the vehicle approaches obstacle 12 although the vehicle has laterally passed the obstacle.

It is apparent from the illustration according to FIG. 2 that the driving direction of vehicle 10 has changed. While in the illustration according to FIG. 1, the vehicle was travelling straight ahead in driving direction 16, the vehicle has moved to the left according to trajectory 30, as illustrated in FIG. 2, and has approached objects 12, previously detected while passing by ultrasonic signals 28 of object detection sensors 14, up to a small distance. FIG. 2 furthermore shows that detection area 24, which is detected by camera system 22 in the rear area of vehicle 10, has changed compared to the area which is detected by camera system 22 at a first recording point in time 48 when the vehicle is driving straight ahead in driving direction 16. This means that a video image 36 recorded at first recording point in time 48 differs from second recorded video image 38 which is recorded at a second recording point in time 50 (cf. illustration according to FIG. 2) during the left-hand movement of vehicle 10. Both video images 36, 38 are recorded at different recording points in time 48, 50 by camera system 22; with the aid of these images, it is possible to ascertain the relative movement of vehicle 10 with regard to its surroundings.

For the sake of completeness, it should be mentioned that vehicle is 10 in its position relative to object 12 includes the same components of a retrofitting kit, i.e., at least one object detection sensor 14, at least one control unit 18, and a camera system 22 (situated here in the rear area of vehicle 10). The individual components, object detection sensors 14, control unit 18, and camera system 22, are interconnected via connecting lines 20, which are used for data exchange between the aforementioned components, similarly to the illustration in FIG. 1.

A comparison between FIGS. 1 and 2 and the positions of vehicle 10 illustrated therein results in that vehicle movement 30 relative to object 12 detected previously by sensors 14 may be tracked with the aid of first video image 36, which was recorded at first recording point in time 48 by camera system 22 and transmitted to control unit 18, and by transmitting another, second video image 38, which was recorded at a second recording point in time 50 by camera system 22 and transmitted to control unit 18. For this purpose, video images 36, 38 recorded at different recording points in time 48, 50 with regard to the movement of camera system 22, which is fixedly installed in vehicle 10, are evaluated in relation to the surroundings. Arithmetically relating vehicle movement 30 detected by the evaluation of video images 36, 38 to installation position 44 of camera system 22 and object detection sensors 14, also situated stationary on vehicle 10, allows vehicle movement 30 to be evaluated. Furthermore, vehicle movement 30 detected by the camera system is put in relation to a vehicle point of rotation 46, here the center of the rear axle of vehicle 10, for example.

Based on this linkage, a relative position change of vehicle 10 relative to previously detected object 12 is determined. In the illustration according to FIG. 2 it is indicated that a warning signal is generated in the case of vehicle 10 approaching object 12 on the left-hand side of vehicle 10 detected previously by control unit 18 during passing according to FIG. 1. The warning signal may be an acoustic and/or a visual warning signal, similarly to those from the driver assistance systems for parking, so that it is pointed out to the vehicle driver that a collision with stationary object 12 is imminent.

It is apparent from the illustration according to FIG. 3 how the information, i.e., video images of the camera systems and the information recorded by the object detection sensors, are linked to one another.

FIG. 3 shows that when video images 36, 38 recorded at different recording points in time 48, 50 are superposed, a video image shift 40 is detected among these. This superposition is transmitted to control unit 18 by way of a combination 42. The detection of a video image shift 40, i.e., the detection of a vehicle movement 30 relative to the surroundings, is continuously recorded by camera system 22 and is also continuously transmitted to control unit 18.

Furthermore, object detection 34 by object detection sensors 14 is also transmitted to the control unit. Object 12 (cf. the illustration according to FIGS. 1 and 2) is detected according to FIG. 1 by at least one object detection sensor 14 while the vehicle passes the object and is tracked with regard to its position relative to vehicle 10 according to the movement of the latter, so that it is no longer necessary to directly detect object 12 by the distance sensors at the point in time of outputting an acoustic or a visual warning, since the object is already classified as detected in control unit 18.

A relative position change of vehicle 10 and object 12 detected previously during passing according to FIG. 1 may be determined with the aid of the evaluation of vehicle movement 30 relative to the surroundings determined by the evaluation of video images 36 and 38 detected at different recording points in time 46, 48, taking into account the installation position of camera system 22 in the vehicle and the position and the at least one object detection sensor 14 as well as taking into account reference point 46. DS object detection diagram 34 symbolizes a group of pieces of information. In this group of pieces of information, the distance values obtained by object detection sensors 14 are included. These pieces of information are combined with the pieces of information which are obtained from the recording of images of camera system 22 and from chronological shifts 40 lying between these images.

Accordingly, due to the illustration in FIG. 2 of vehicle 10 approaching stationary object 12, the relative position change of the vehicle relative to object 12 detected previously may be determined, and, as a function of the computed distance between vehicle 10 relative to object 12, a suitable piece of warning information may be output to the driver, e.g., an acoustic alert or light emitting diodes (LEDs) blinking in different colors.

The method proposed according to the present invention for ascertaining a relative position between a vehicle 10 and an object 12 located laterally to the vehicle advantageously does not need any on board data bus, in particular no CAN data bus access. This advantageously results in the components of the method proposed according to the present invention being implementable cost-effectively as stand-alone systems without being linked to other systems installed in vehicle 10. Only a connection to the electrical system of vehicle 10 is necessary.

In particular, the components may be configured as a retrofitting kit for a subsequent implementation of a driver assistance system for ascertaining a relative position between vehicle 10 and an object 12 located laterally to the vehicle. This retrofitting kit advantageously includes at least one object detection sensor 14, which is subsequently installable on the vehicle, e.g., for installation in the fender area of vehicle 10, a control unit 18, which, on the one hand, may be connected to the electrical system of vehicle 10 and, on the other hand, may include an output unit for outputting an acoustic and/or visual warning to the vehicle driver when the vehicle approaches object 12, as well as a camera system 22, which may be a video camera system in particular.

While camera system 22 has been described above in conjunction with FIGS. 1 and 2 with regard to an installation position 44 intended in the rear area of vehicle 10, camera system 22, which may be configured as a video camera, may also be mounted in the vehicle in the area of the windshield or also laterally. The only important thing is the fixed installation point of camera system 22 in vehicle 10, since the movement of the camera system relative to the surroundings of vehicle 10 is ascertained with the aid thereof. A reference point 46, for example a vehicle point of rotation such as the center of the rear axle of vehicle 10, was previously defined. Naturally, other reference points 46 may also be defined.

The retrofitting kit, i.e., the stand-alone unit, of the device proposed according to the present invention for ascertaining a relative position between a vehicle 10 and an object 12 located laterally to the vehicle includes, in addition, the at least one object detection sensor 14, control unit 18, and camera system connecting lines 22, which in particular include a video camera and which may also be wired subsequently in the vehicle, e.g., in the ceiling of the same, so that the installation of the retrofitting kit may also take place in a visually appealing manner.

The method proposed according to the present invention for ascertaining a relative position between a vehicle 10 and an object 12 located laterally to the vehicle may also be used within the scope of a passive parking guidance in its implementation as a subsequently installable retrofitting kit. This functionality of the retrofitting kit proposed according to the present invention, in which the visual odometry is utilized, makes it possible to detect a parking spot, while vehicle 10 passes by it, with the aid of object detection sensors 14, e.g., ultrasonic sensors. The obtained information with regard to the length and the depth or also a is position angle of the parking spot may be measured with the aid of the recorded signals. Camera system 22 proposed according to the present invention may detect a position change of vehicle 10, and this information may be input into a virtual map which enables the recognition and classification, as well as the measurement of the parking spot.

In addition to this type of parking spot measurement, a passive guidance into this parking spot may be achieved using the approach proposed according to the present invention. For this purpose, an optimal parking trajectory is computed by reverting to the previously obtained information regarding the position, the size, and the angular position of the parking spot, and the vehicle position of the host vehicle relative to this parking spot. This computed trajectory makes it possible to offer steering instructions to the driver so that the steering movements result in a movement of vehicle 10 along this computed trajectory. Moreover, instructions may be output to the driver for the route to be driven and the direction, which takes place, for example, until the next steering instruction is available.

During the output of instructions, in particular steering instructions, to the driver, the instantaneous, actual vehicle position is always taken into account on the computed trajectory. If the actual vehicle position changes, the trajectory is recomputed, i.e., newly recognized obstacles lying on the previously computed vehicle trajectory are also taken into account. With the aid of the approach proposed according to the present invention, the following functions may be carried out during this phase:

Camera system 22 allows the position change of vehicle 10 to be detected. Thus, a new computation of the trajectory of the deviation therefrom is possible. This results in updated information which may be output to the driver, e.g., the information regarding how far driving is possible with the instantaneous steering angle. This is connection makes it possible to ask the driver to reach a stopping point on a trajectory segment at the constant steering angle and to predefine a new steering angle. Furthermore, it is possible to input the information detected, while driving, by object detection sensor 14 into an internally visual map, so that this information may be incorporated into the trajectory planning of an object warning be output visually or acoustically.

1-10. (canceled)

11. A method for ascertaining a relative position between a vehicle and an object located laterally to the vehicle, the method comprising:
detecting the object by at least one lateral object detection sensor as the vehicle passes;
detecting a vehicle movement by a camera system which is situated in one of a rear area of the vehicle, an area of the windshield of the vehicle, and an area of a side window of the vehicle, and which generates video images at different recording points in time;
linking the detected vehicle movements to an installation position of the camera system, the position being of the at least one lateral object detection sensor and a vehicle point of rotation;
determining a relative position change of the vehicle relative to the object detected previously according to the task of detecting the object.

12. The method of claim 11, wherein the camera system continuously generates video images during the vehicle movement.

13. The method of claim 11, wherein the vehicle movement occurs based on the video images relative to an object detected previously according to the task of detecting the object.

14. The method of claim 11, wherein the video images are evaluated in a control unit with regard to the movement of the camera system relative to the surroundings of the vehicle.

15. The method of claim 11, wherein at least one of an acoustic warning and a visual warning is generated as a function of a distance resulting from the position change of the vehicle relative to the object.

16. A device for ascertaining a relative position between a vehicle and an object located laterally to the vehicle, comprising:
a device arrangement, including:
a detecting arrangement to detect the object by at least one lateral object detection sensor as the vehicle passes, and to detect a vehicle movement by a camera system which is situated in one of a rear area of the vehicle, an area of the windshield of the vehicle, and an area of a side window of the vehicle, and which generates video images at different recording points in time;
a linking arrangement to link the detected vehicle movements to an installation position of the camera system, the position being of the at least one lateral object detection sensor and a vehicle point of rotation;
a determining arrangement to determine a relative position change of the vehicle relative to the object detected previously according to the task of detecting the object.

17. The device of claim 16, wherein the device arrangement is configured as a retrofitting kit for a vehicle, and includes at least one of the following components: at least one object detection sensor which is mountable laterally on the vehicle; a control unit; a camera system; and connecting lines for establishing data transmission between these components.

18. The device of claim 17, wherein the control unit includes at least one of an acoustic output unit and a visual output unit for providing a warning signal.

19. The device of claim 17, wherein the control unit is independent of the information from an on board data transmission system, which includes a CAN bus.

20. The device of claim 17, wherein the camera system is mounted in one of a rear area of the vehicle, an area of the windshield of the vehicle, and an area of a side window of the vehicle.

21. The device of claim 17, wherein the camera system is installed in a reference point with regard to a vertical axis of the vehicle, with regard to a vehicle point of rotation.
